(19) United States
(12) Patent Application Publication
(10) Pub. No.: US 2010/0023414 A1
(43) Pub. Date: Jan. 28, 2010

(54) ALLOCATION AND PRICING OF INFORMATION DISTORTION FOR SPECIFYING A DISPLAY

(75) Inventors: Mohammad Mahdian, Santa Clara, CA (US); Michael Schwarz, Berkeley, CA (US)

Correspondence Address: YAHOO! INC.;c/o DUANE MORRIS LLP, Attn.: IP Docketing, 30 SOUTH 17TH STREET, Philadelphia, PA, 19103-4196, US

(73) Assignee: YAHOO! INC., Sunnyvale, CA (US)

(21) Appl. No.: 12/181,209

(22) Filed: Jul. 28, 2008

(51) Int. Cl. G06Q 30/00; G06Q 10/00; G06Q 99/00

(52) U.S. Cl. 705/26; 705/1; 705/400

(57) ABSTRACT

A method of determining a display specification, includes: specifying business parameters for calculating a business value for the display specification, wherein the display specification includes a plurality of display locations and corresponding display values that are associated with business entities; specifying user parameters for calculating a user value for the display specification; selecting the display specification to improve a combination of the business value and the user value; and saving one or more values for the display specification (e.g., saving values for the display specification directly or through some related characterization.).

### BACKGROUND OF THE INVENTION

1. Field of Invention

The present invention relates to information processing generally and more particularly to specifying a display based on valuations of information content.

2. Description of Related Art

Many publishers, online or offline, provide information in the form of listings of businesses, websites, etc. Examples include search engines, yellow pages, comparison shopping sites, etc. The common practice in publishing is to take one of the two extremes: either to provide a listing that maximizes the value to the audience (as in organic search results of search engines) [2], or to sell a clearly-marked advertising space to paying advertisers [1, 4]. In certain contexts such as comparison shopping sites (such as Yahoo! shopping) or yellow pages, it makes sense for the publisher not to restrict herself to one of these two extremes: if the publisher (e.g., the administrator of the comparison shopping site, or the publisher of the yellow pages) decides to only display information from paying advertisers, the value of the site/publication to the users can decrease, causing some of the users to use other sites/publications. On the other hand, if the publisher decides to display only content that provides the maximum value to the user, it cannot generate any revenue.

Thus, there is a need for improved methods for determining displays in ways that combine the needs of users and businesses.

### SUMMARY OF THE INVENTION

In one embodiment of the present invention, a method of determining a display specification, includes: specifying business parameters for calculating a business value for the display specification, wherein the display specification includes a plurality of display locations and corresponding display values that are associated with business entities; specifying user parameters for calculating a user value for the display specification; selecting the display specification to improve a combination of the business value and the user value; and saving one or more values for the display specification (e.g., saving values for the display specification directly or through some related characterization).

According to one aspect of this embodiment the display locations may include portions of a web page and the display values include visual identifiers for the business entities.

According to another aspect, the business parameters may include maximum bid values for combinations of the business entities and the display locations.

According to another aspect, the user parameters may include user utility values for combinations of the business entities and the display locations.

According to another aspect, the combination of the business value and the user value may be a linear combination that is scaled to monetary units.

According to another aspect, selecting the display specification may include selecting a sequence of the business entities for allocation with a prescribed sequence of the display locations.

According to another aspect, the method may further include using the business parameters and the user parameters to calculate prices for the business entities corresponding to the display specification, wherein the prices are bounded by maximum bids set by the business entities and each price characterizes an effect of a corresponding maximum bid on selecting the display specification.

Additional embodiments relate to an apparatus for carrying out any one of the above-described methods, where the apparatus includes a computer for executing instructions related to the method. For example, the computer may include a processor with memory for executing at least some of the instructions. Additionally or alternatively the computer may include circuitry or other specialized hardware for executing at least some of the instructions. Additional embodiments also relate to a computer-readable medium that stores (e.g., tangibly embodies) a computer program for carrying out any one of the above-described methods with a computer. In these ways the present invention enables improved methods for determining displays in ways that combine the needs of users and businesses.

### BRIEF DESCRIPTION OF THE DRAWINGS

FIG. 1 shows an exemplary method for determining a display specification for an embodiment of the present invention.

FIGS. 2 and 3 shows details for a specific embodiment related to the embodiment shown in FIG. 1.

FIG. 4 shows a conventional general purpose computer.

FIG. 5 shows a conventional Internet network configuration.

### DETAILED DESCRIPTION OF EXEMPLARY EMBODIMENTS

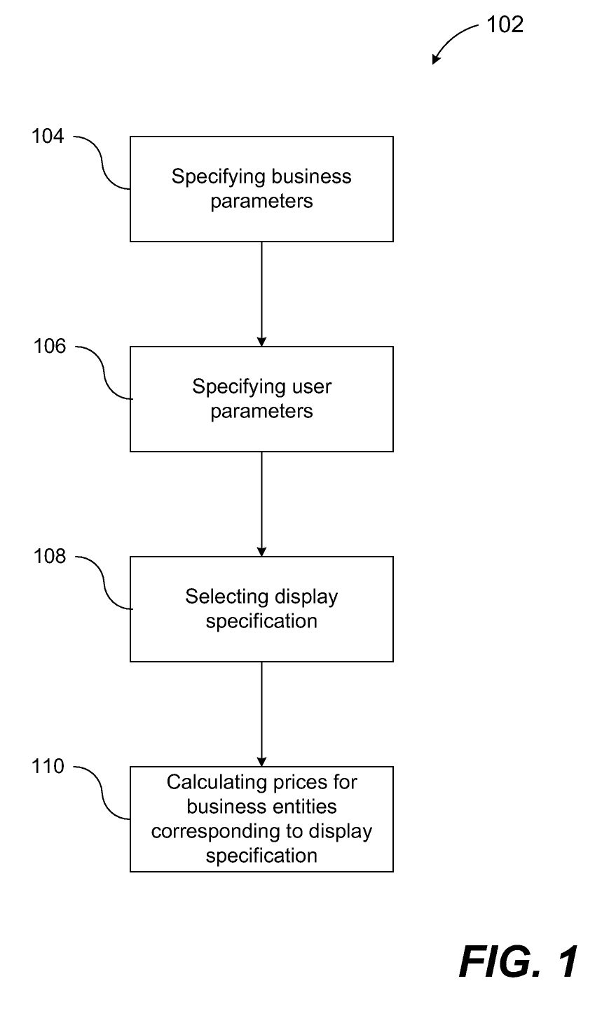

An embodiment of the present invention is shown in FIG. 1. A method 102 of determining a display specification includes: specifying business parameters 104 for calculating a business value for the display specification, specifying user parameters 106 for calculating a user value for the display specification, selecting the display specification 108 to improve a combination of the business value and the user value (e.g., as a part of an optimization process), and calculating prices 110 for the business entities corresponding to the display specification. As discussed below in greater detail, the display specification typically includes display locations (e.g., on a web page) and corresponding display values that are associated with business entities. And the calculated prices can be bounded by maximum bids set by the business entities and further specified so that each price characterizes an effect of a corresponding maximum bid on selecting the display specification.

As a specific example, assume there are n businesses bᵢ (i=1, 2, . . . , n), at least some of which are bidding to be displayed on a listing that includes k display locations dⱼ (j=1, 2, . . . , k). In the most general case, the listing does not have to be “one-dimensional”, e.g., a web page provides a two-dimensional space to display information. If the information displayed changes over time, time can also be considered as a dimension of the listing. Business bᵢ bids a value of vᵢⱼ for being displayed in position dⱼ. Typically there are more bidders than locations (e.g., n>k), and, for convenience, we assume a business that does not bid has submitted a bid of zero (0).

The publisher who owns the display must decide which businesses to display on the listing, and in which order. Let π=(π(1), π(2), π(3), . . . , π(k)) be an ordered set of businesses that specifies how businesses are assigned to the k display locations (e.g., for placing advertisements). As discussed above, the publisher may wish to balance the utility interests of both the businesses and the users.

For example, a function g may be proposed to capture the value to the businesses as g(π). Using the bid values as characterizations for value to the users, one has g(π)=Σⱼv_{π(j),j}.

Assume we have a function ƒ, which, given an ordered set π of businesses (or advertisers), gives the value ƒ(π) of this listing for the audience of users. Various definitions of this function are possible depending on the user utility that is being captured, including measures of attention, follow-up activities, and characterizations the subjective importance of the underlying information. In an online setting, perhaps the simplest way to model this function is to let ƒ(π) be proportional to the sum of click-through rates of displayed links as illustrated more specifically below.

Then the decision for the publisher in this context is to specify π the ordered set of business for the k display locations. Additionally, the publisher can specify corresponding ordered set of prices p=(p(1), p(2), p(3), . . . , p(k)). These prices should be rational in the sense that they are no more than the corresponding bid values (i.e, p(j)≦v_{π(j),j}). Additionally, it is desirable to set the prices to reflect the economic externalities induced by the bids.

The well-known Vickrey-Clark-Groves (VCG) mechanism can be applied to this setting [3, 5]. This mechanism selects an allocation that maximizes the total utility that the bidders and the auctioneer receive. For the example described above, we can think of the value ƒ(π) as the value that the auctioneer derives through the users from an allocation π. In other words, we let the auctioneer represent not only the publisher, but also the users; hence, the utility of the auctioneer for an allocation π is ƒ(π) plus the sum of payments the publisher receives from the businesses. With this way of modeling the auctioneer as an entity that represents both the publisher and the users, the outcome computed by the VCG mechanism is the one that selects π=(π(1), π(2), π(3), . . . , π(k)) to maximizes the combined utility function

ƒ(π)+Σⱼv_{π(j),j}. (1)

Note that Eq. (1) could include a scaling parameter (0<α≦1) on one of the terms to shift the balance between user utility and business utility.

The VCG mechanism charges each business the externality that this business imposes on others. This can be computed as follows: if π* is an ordered subset of all businesses that maximizes Eq. (1) and π*₋ᵢ is an ordered subset of all businesses that maximizes this function when the bid of business i is changed to zero (0) then the amount the ith business is charged is equal to the price p(i) given by

$$f ( {π}_{- i}^{*} ) + {\sum }_{j \text{:} {π}_{- i}^{*} ( j ) \neq i} {v}_{{π}_{- i}^{*} ( j ) , j} - ( f ( {π}^{*} ) + {\sum }_{j \text{:} {π}^{*} ( j ) \neq i} {v}_{{π}^{*} ( j ) , j} ) . \qquad ( 2 )$$

An important property of the VCG mechanism is that it is dominant-strategy incentive compatible; that is, the best strategy of each business is to bid her true value, independent of the actions of other businesses. It should be noted that the i'th business might still be chosen in π*₋ᵢ because of the value it provides to the users. And also, as noted above, Eq. (1) could include a scaling parameter (0<α≦1) on one of the terms to shift the balance between user utility and business utility.

As a more specific example, assume a setting where a publisher needs to create an online listing of n businesses, and each business i has a fixed value vᵢ for each click, independent of which position the click is coming from. Also, assume the click-through rates are separable, i.e., the click-through rate of the a link to business i placed in position j can be estimated as αᵢβⱼ, where αᵢ is a number only depending on the business i, and, βⱼ is a number only depending on the position j. Using this notation, the value of business i for an impression in position j can be written as vᵢⱼ=vᵢαᵢβⱼ. Furthermore, assume ƒ is proportional to the sum of click-through rates, i.e., ƒ(π)=CΣⱼα_{π(j)}βⱼ, where C is a constant. In this model, the VCG mechanism selects an ordered list π that maximizes the function

$$f ( π ) + {\sum }_{j} {v}_{π ( j )} = {\sum }_{j} ( {v}_{π ( j )} + C ) {α}_{π ( j )} {β}_{j} . \qquad ( 3 )$$

If βⱼ's are ordered in decreasing order (i.e., β₁≧, β₂≧ . . . ≧βₖ), this allocation can be calculated by simply ordering the businesses in decreasing order of their (vᵢ+C)αᵢ values, and assigning them to positions in this order. Note that a business with vᵢ=0 (i.e., a business that is not willing to pay for being displayed) but a high αᵢ can still be displayed by this algorithm. Assuming the businesses are re-indexed such that (v₁+C)α₁≧(v₂+C)α₂≧ . . . ≧(vₙ+C)αₙ, the i'th business (1≦i≦k) will be charged an amount equal to

$${\sum }_{j = i + 1}^{l} ( {β}_{j - 1} - {β}_{j} ) ( {v}_{j} + C ) {α}_{j} - C {α}_{i} ( {β}_{i} - {β}_{l} ) , \qquad ( 4 )$$

where l is an index such that (vₗ+C)αₗ≧Cαᵢ≧(vₗ₊₁+C)αₗ₊₁.

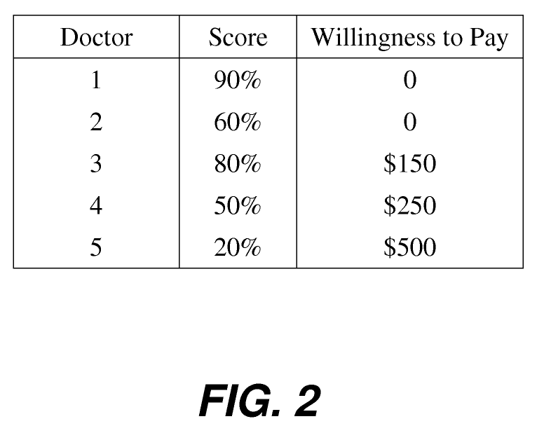

To evaluate this process with numerical values, assume further that the publisher is creating a listing of doctors in a small town. There are five (5) doctors in this town, numbered 1 through 5. FIG. 2 shows a table with a row entry for each doctor. The publisher has estimated that the percentage of clients that have been happy with the service provided by each of these doctors are as specified in the second column labeled “Score.” Furthermore, the publisher has negotiated with each doctor the maximum amount each doctor is willing to pay for a listing and these values are listed in the third column labeled “Willingness to Pay.”

Due to space constraints, the publisher wants to list only four doctors in the listing, and has estimated that the satisfaction of the users of the listing can be calculated by adding up the score of the doctor listed first, the score of the doctor listed second divided by two, the score of the doctor listed third divided by three, and the score of the doctor listed fourth divided by four, and multiplying the sum by $10. For example, if the doctors are listed in decreasing order of their scores (i.e., doctors 1, 3, 2, and 4 are listed in this order), the monetary value of the user satisfaction will be:

$$\$10 \times ( \frac{90}{1} + \frac{80}{2} + \frac{60}{3} + \frac{50}{4} ) = \$1625 . \qquad ( 5 )$$

As discussed above, the publisher has negotiated with the doctors and has evaluated the maximum amount each doctor is willing to pay to be listed. Assume the amounts each of them is willing to pay if they are listed in the first place in the listing are as in the third column of the above table, and the amount a doctor is willing to pay if they are listed in some other position i (i=2, 3, or 4) is given by the amount they willing to pay for the first position, divided by i. For example, if the doctors are ordered in decreasing order of their scores, their total willingness-to-pay (i.e., the total value to the doctors) is:

$$\frac{0}{1} + \frac{\$150}{2} + \frac{0}{3} + \frac{\$250}{4} = \$137 .5 . \qquad ( 6 )$$

On the other hand, if the doctors are ordered in decreasing order of their willingness to pay, that is, if the listing includes doctors 5, 4, 3, and 1, in this order, their total value will be:

$$\frac{\$500}{1} + \frac{\$250}{2} + \frac{\$150}{3} + \frac{0}{4} = \$675 . \qquad ( 7 )$$

However, in this ordering the value of the user satisfaction will be:

$$\$10 \times ( \frac{20}{1} + \frac{50}{2} + \frac{80}{3} + \frac{90}{4} ) \approx \$941 .75 . \qquad ( 8 )$$

Therefore, the total value of the ordering based on scores (from Eqs. (5) and (6)) is $1625+$137.5=$1762.5, and the total value of ordering based on doctors' values (from Eqs. (7) and (8)) is $941.7+$675=$1616.7.

However, the solution that maximizes the total value according to the VCG mechanism described above is to include doctors 3, 1, 4, and 5, in this order. The user satisfaction value of this ordering is

$$\$10 \times ( \frac{80}{1} + \frac{90}{2} + \frac{50}{3} + \frac{20}{4} ) \approx \$1466 .7 , \qquad ( 9 )$$

and the value to doctors is

$$\frac{\$150}{1} + \frac{0}{2} + \frac{\$250}{3} + \frac{\$500}{4} \approx \$358 .3 , \qquad ( 10 )$$

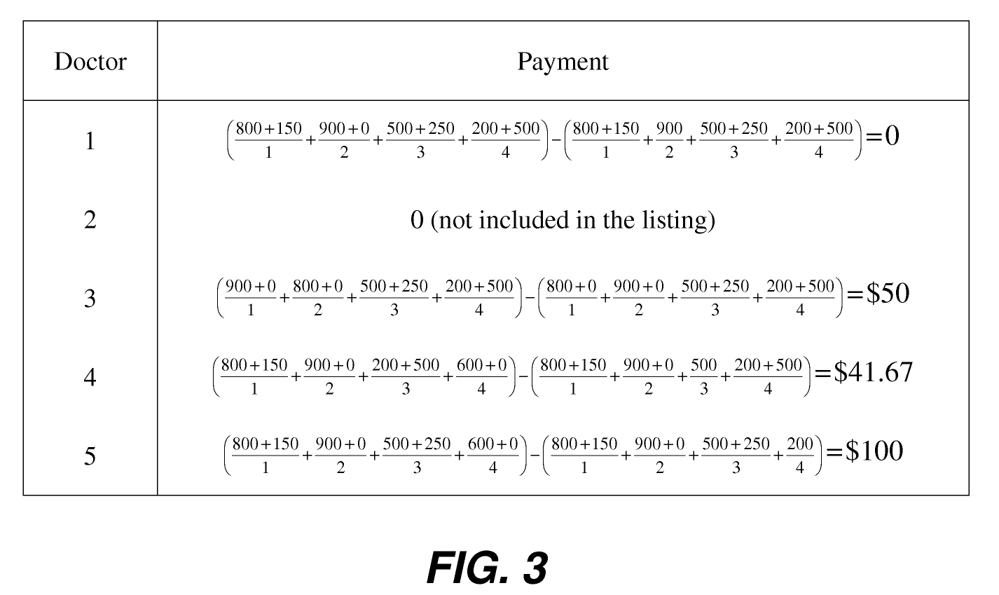

so that the total combined value is $1466.7+$358.3=$1825. The amount the doctors will be charged can be computed using Eq. (2) and is given in the table shown in FIG. 3. Note that this solution includes non-paying doctor number 1 in the listing.

At least some values for the results of the method can be output to a user or saved for subsequent use. For example the selected businesses π and prices p can be saved directly for future commercial operations. Alternatively, some derivative or summary form of the results (e.g., averages, interpolations, etc.) can be saved for later use according to the requirements of the operational setting.

Additional embodiments relate to an apparatus for carrying out any one of the above-described methods, where the apparatus includes a computer for executing computer instructions related to the method. In this context the computer may be a general-purpose computer including, for example, a processor, memory, storage, and input/output devices (e.g., keyboard, display, disk drive, Internet connection, etc.). However, the computer may include circuitry or other specialized hardware for carrying out some or all aspects of the method. In some operational settings, the apparatus may be configured as a system that includes one or more units, each of which is configured to carry out some aspects of the method either in software, in hardware or in some combination thereof. For example, the system may be configured as part of a computer network that includes the Internet.

At least some values for the results of the method can be saved, either in memory (e.g., RAM (Random Access Memory)) or permanent storage (e.g., a hard-disk system) for later use. For example the selected businesses π and prices p can be saved directly for future commercial operations.

Additional embodiments also relate to a computer-readable medium that stores (e.g., tangibly embodies) a computer program for carrying out any one of the above-described methods by means of a computer. The computer program may be written, for example, in a general-purpose programming language (e.g., C, C++) or some specialized application-specific language. The computer program may be stored as an encoded file in some useful format (e.g., binary, ASCII).

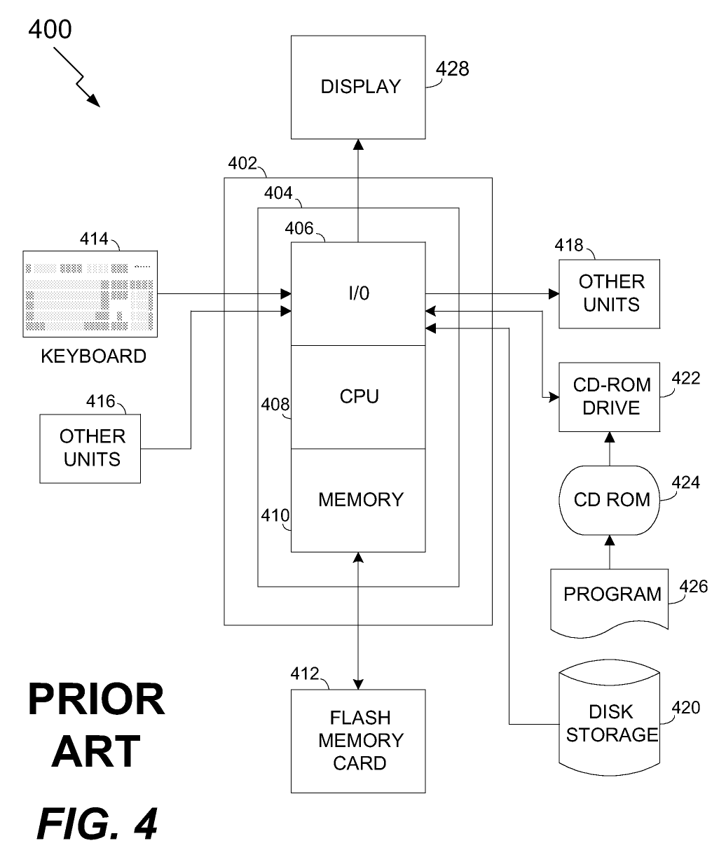

As described above, certain embodiments of the present invention can be implemented using standard computers and networks including the Internet. FIG. 4 shows a conventional general purpose computer 400 with a number of standard components. The main system 402 includes a motherboard 404 having an input/output (I/O) section 406, one or more central processing units (CPU) 408, and a memory section 410, which may have a flash memory card 412 related to it. The I/O section 406 is connected to a display 428, a keyboard 414, other similar general-purpose computer units 416, 418, a disk storage unit 420 and a CD-ROM drive unit 422. The CD-ROM drive unit 422 can read a CD-ROM medium 424 which typically contains programs 426 and other data.

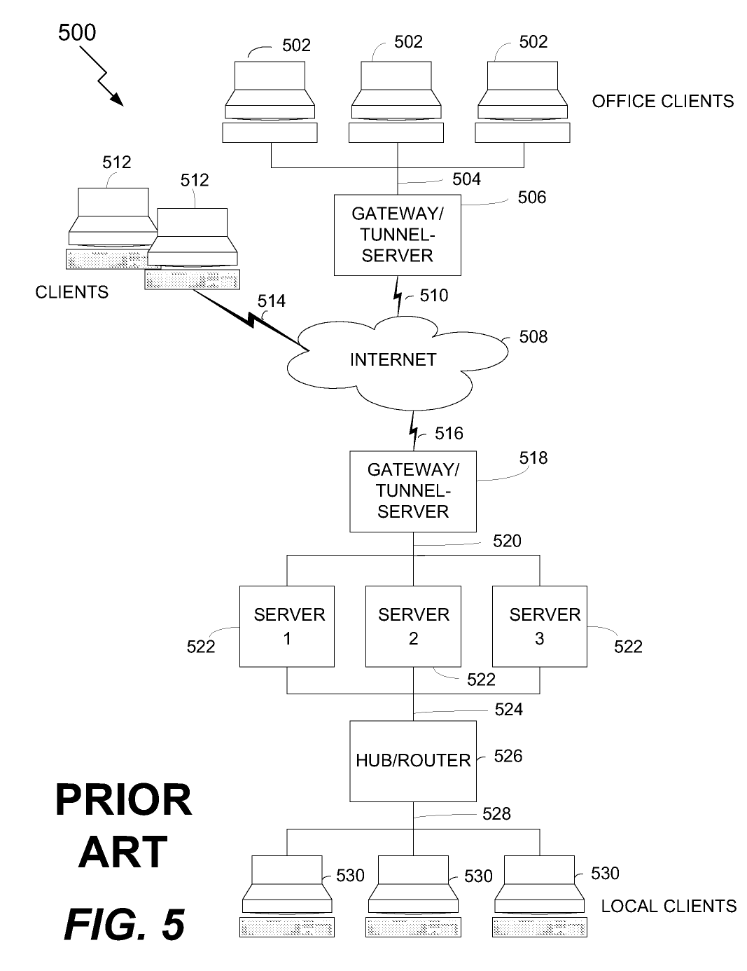

FIG. 5 shows a conventional Internet network configuration 500, where a number of office client machines 502, possibly in a branch office of an enterprise, are shown connected 504 to a gateway/tunnel-server 506 which is itself connected to the Internet 508 via some internet service provider (ISP) connection 510. Also shown are other possible clients 512 similarly connected to the internet 508 via an ISP connection 514. An additional client configuration is shown for local clients 530 (e.g., in a home office). An ISP connection 516 connects the Internet 508 to a gateway/tunnel-server 518 that is connected 520 to various enterprise application servers 522. These servers 522 are connected 524 to a hub/router 526 that is connected 528 to various local clients 530.

Although only certain exemplary embodiments of this invention have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

The following references are related to the disclosed subject matter:
[1] B. Edelman, M. Ostrovsky, and M. l Schwarz, “Internet Advertising and the Generalized Second Price Auction: Selling Billions of Dollars Worth of Keywords,” American Economic Review, v. 97(1), March 2007, pp. 242-259.
[2] J. Kleinberg, “Authoritative sources in a hyperlinked environment,” Journal of the ACM 46 (1999).
[3] N. Nisan and A. Ronen, “Computationally Feasible VCG Mechanisms,” Journal of Artificial Intelligence Research, 29 (2007), pp. 19-47.
[4] H. Varian, “Position Auctions,” International Journal of Industrial Organization, October 2006.
[5] W. Vickrey, “Counterspeculation, Auctions, and Competitive Sealed Tenders,” Journal of Finance, 3 (1961), pp. 8-37.

What is claimed is:

1. A method of determining a display specification, comprising:
specifying business parameters for calculating a business value for the display specification, wherein the display specification includes a plurality of display locations and corresponding display values that are associated with business entities;
specifying user parameters for calculating a user value for the display specification;
selecting the display specification to improve a combination of the business value and the user value; and
saving one or more values for the display specification.

2. A method according to claim 1, wherein the display locations include portions of a web page and the display values include visual identifiers for the business entities.

3. A method according to claim 1, wherein the business parameters include maximum bid values for combinations of the business entities and the display locations.

4. A method according to claim 1, wherein the user parameters include user utility values for combinations of the business entities and the display locations.

5. A method according to claim 1, wherein the combination of the business value and the user value is a linear combination that is scaled to monetary units.

6. A method according to claim 1, wherein selecting the display specification includes selecting a sequence of the business entities for allocation with a prescribed sequence of the display locations.

7. A method according to claim 1, further comprising using the business parameters and the user parameters to calculate prices for the business entities corresponding to the display specification, wherein the prices are bounded by maximum bids set by the business entities and each price characterizes an effect of a corresponding maximum bid on selecting the display specification.

8. An apparatus for determining a display specification, the apparatus comprising a computer for executing computer instructions, wherein the computer includes computer instructions for:
specifying business parameters for calculating a business value for the display specification, wherein the display specification includes a plurality of display locations and corresponding display values that are associated with business entities;
specifying user parameters for calculating a user value for the display specification;
selecting the display specification to improve a combination of the business value and the user value; and
saving one or more values for the display specification.

9. An apparatus according to claim 8, wherein the computer includes a processor with memory for executing at least some of the computer instructions.

10. An apparatus according to claim 8, wherein the computer includes circuitry for executing at least some of the computer instructions.

11. An apparatus according to claim 8, wherein the display locations include portions of a web page and the display values include visual identifiers for the business entities.

12. An apparatus according to claim 8, wherein the business parameters include maximum bid values for combinations of the business entities and the display locations.

13. An apparatus according to claim 8, wherein the user parameters include user utility values for combinations of the business entities and the display locations.

14. An apparatus according to claim 8, wherein the combination of the business value and the user value is a linear combination that is scaled to monetary units.

15. An apparatus according to claim 8, wherein selecting the display specification includes selecting a sequence of the business entities for allocation with a prescribed sequence of the display locations.

16. An apparatus according to claim 8, wherein the computer further includes computer instructions for: using the business parameters and the user parameters to calculate prices for the business entities corresponding to the display specification, wherein the prices are bounded by maximum bids set by the business entities and each price characterizes an effect of a corresponding maximum bid on selecting the display specification.

17. A computer-readable medium that stores a computer program for determining a display specification, wherein the computer program includes instructions for:
specifying business parameters for calculating a business value for the display specification, wherein the display specification includes a plurality of display locations and corresponding display values that are associated with business entities;
specifying user parameters for calculating a user value for the display specification;
selecting the display specification to improve a combination of the business value and the user value; and
saving one or more values for the display specification.

18. A computer-readable medium according to claim 17, wherein the display locations include portions of a web page and the display values include visual identifiers for the business entities.

19. A computer-readable medium according to claim 17, wherein the business parameters include maximum bid values for combinations of the business entities and the display locations.

20. A computer-readable medium according to claim 17, wherein the user parameters include user utility values for combinations of the business entities and the display locations.

21. A computer-readable medium according to claim 17, wherein the combination of the business value and the user value is a linear combination that is scaled to monetary units.

22. A computer-readable medium according to claim 17, wherein selecting the display specification includes selecting a sequence of the business entities for allocation with a prescribed sequence of the display locations.

23. A computer-readable medium according to claim 17, wherein the computer program further includes instructions for using the business parameters and the user parameters to calculate prices for the business entities corresponding to the display specification, wherein the prices are bounded by maximum bids set by the business entities and each price characterizes an effect of a corresponding maximum bid on selecting the display specification.
